(19) United States
(12) Patent Application Publication
(10) Pub. No.: US 2005/0177409 A1
(43) Pub. Date: Aug. 11, 2005

(54) Method and computer system for schedule bidding

(76) Inventor: Meghan M. Barni, Mahopac, NY (US)

Correspondence Address: David H. Judson;Locke, Liddell & Sapp, Suite 2200, 2200 Ross Avenue, Dallas, TX, 75201, US

(21) Appl. No.: 10/775,466

(22) Filed: Feb. 10, 2004

(51) Int. Cl. G06F 17/60

(52) U.S. Cl. 705/9

(57) ABSTRACT

A method and computer system for assigning one or more schedules to a plurality of entities such as agents or employees. Schedules are posted online and can be viewed by, and bid upon, the entities to be scheduled. Entities preferably enter their individual schedule preferences. Schedules preferably are sorted in order of priority, based on the entity's preferences. The entities then bid on the schedules. The bidding for each set of schedules is then closed. The supervisor then initiates a process that sorts the entities in a specified order and assigns a schedule to each of the entities, based on their bids.

### BACKGROUND OF THE INVENTION

1. Technical Field

The invention relates generally to computer-implemented agent or employee scheduling in a work center environment.

2. Description of the Related Art

Typically, scheduling workers is a manual process that is time-consuming for both employees and supervisors. Supervisors print up and make available different schedules to workers, such as day, evening or night shift, and a particular schedule typically includes various attributes, such as different lunch and break times available. For example, a day shift schedule, starting at 8 am and ending at 4 pm, might have a number of possible lunch times starting at 11:00 am, 11:30 am, 12:00 noon, 12:30 pm, and 1:00 pm. Of course, the problem is exacerbated because employees have their own preferences, such as which shift they want to work, how well the shift suits their lifestyle, and when they want to have their lunch and other breaks. Scheduling employees for such varied work shifts is extremely time consuming and ad hoc. In a common scenario, schedules are posted on the wall of a supervisor's office or conference room and employees are then scheduled manually to come into the room in seniority or rank order and sign their name by the schedule they want. In another common scenario, employees rank the available schedules based on their preferences and submit bids to the supervisor. The supervisor then sorts through the submitted bids from employees in seniority or rank order and manually assigns each employee a schedule, based on the employee's rankings of the schedules.

These manual processes (including, among other things, printing schedules, employee bidding, and then assigning employees to schedules) are very time consuming for both employees and their supervisor.

Thus, there remains a need for an improved method of schedule bidding and schedule assignment.

### BRIEF SUMMARY OF THE INVENTION

It is an object of the present invention to enable entities in a work environment to view and bid for schedules online.

It is another object of the invention to provide a method and computer system for schedule bidding that eliminates manual schedule distribution and data entry from paper sign-up sheets.

It is another more specific object of the invention to provide techniques whereby agents in a contact center work environment use a Web browser-based schedule bid display to view sets of schedules and then rank their schedule preferences. Preferably, after a bidding cycle is closed, bids are automatically processed in seniority or other ranking order.

It is a further object of the invention to provide a method and computer system to enable a supervisor to specify which schedules are available for bidding, which data items (e.g., lunch times, number of slots, and the like) are available to be seen by the agents who will be bidding, and the date range for which the schedules will be available for bidding. More generally, the supervisor (or other management entity) can enter special instructions and specify what is displayed to agents in a schedule bid display screen. As a result, agents only see the schedules for a particular group. After an agent has bid on a schedule, he or she can then view it or modify his or her bid.

It is another object of the invention to provide a schedule bidding system wherein employees are allowed to see and bid on schedules for which a supervisor has given them permissions. Once a bid is closed, a supervisor may initiate a process that assigns employees to schedules, e.g., based on a specified employee ranking method and each employee's bids.

It is another more general object of the invention to enable entities (e.g., agents, employees, and the like) in a work environment such as a contact center to view and submit bids for schedules using a Web browser, rather than paper. Using the system, employees can sort schedules according to whatever criteria is most important to them, which makes bidding more efficient and satisfying. An auto-rank feature preferably automatically ranks the schedules in a current order, which saves time. Once employees have bid, an assignment process executed by a supervisor eliminates time-consuming manual assignments.

In a representative embodiment, the present invention provides a method and computer system for assigning one or more schedules to a plurality of employees. Schedules are posted online and can be viewed, and bid upon, by employees. Employees preferably enter their individual schedule sort preferences. Schedules preferably are sorted in order of priority, based on the employee's preferences. Employees then bid on the schedules. The bidding for each set of schedules is then closed at a given time. The supervisor then initiates a process that sorts the employees in a specified order and assigns a schedule to each of the employees, preferably based on their bids.

The foregoing has outlined some of the more pertinent features of the invention. These features should be construed to be merely illustrative. Many other beneficial results can be attained by applying the disclosed invention in a different manner or by modifying the invention as will be described.

### BRIEF DESCRIPTION OF THE DRAWINGS

For a more complete understanding of the present invention and the advantages thereof, reference is now made to the following descriptions taken in conjunction with the accompanying drawings, in which:

FIG. 1 is an illustrative bidding home display screen according to an embodiment of the present invention;

FIG. 2 is an illustrative bid sort display;

FIG. 3 is an illustrative bid display;

FIG. 4 is an illustrative select schedule pattern set display;

FIG. 5A is an illustrative select agents display screen;

FIG. 5B is an illustrative portion of an Agent select table of FIG. 5A with all fields shown;

FIG. 6 is an illustrative finish assigning agents display screen according to the present invention; and

FIG. 7 is a block diagram of an agent supervisor computer network in which the present invention may be implemented.

### DETAILED DESCRIPTION OF AN EMBODIMENT

In the following discussion, the invention is described in the context of a contact center environment, although it should be understood that the invention can be practiced in other types of environments such as, without limitation, sales force environments, field service environments, manufacturing environments, and other types of environments wherein entities (agents, employees, contractors, other persons, etc.) work according to assigned schedules. In a contact center, the environment generally comprises an automatic call distributor (ACD) and a multimedia server coupled to a host computer via a computer network. The ACD and multimedia server generally provide routing capabilities for incoming voice calls (via the ACD) and other contacts (via the multimedia server), such as faxes, email, voice mail, web requests, web call-back requests, web chats, web voice calls, web video calls, and the like. For ease of discussion, the persons who work at the contact center are referred to herein variously as “agents” or “employees.” These designations are used interchangeably within the following description. Of course, this nomenclature is not meant to be taken to limit the invention in any way, as the word “employee” or the word “agent” is meant to be broadly construed to include any person regardless of a particular legal status. An entity need not actually handle contacts, of course. A “schedule” is any ordered list of times at which given events or activities are planned to occur. Of course, as noted above, the present invention may be implemented in any work environment where entities desire to bid on work or other task schedules.

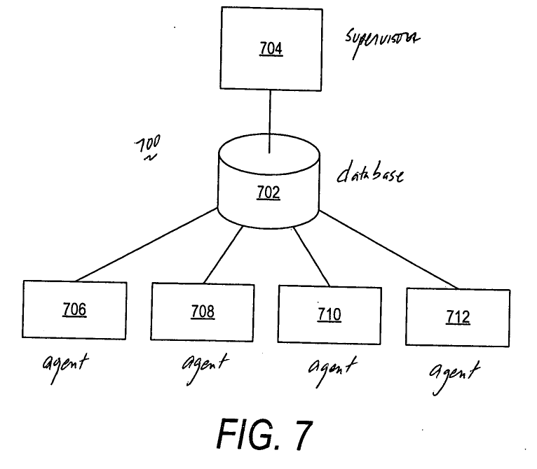

As seen in FIG. 7, a distributed computing environment in which the schedule trading method and system of the invention may be implemented includes a set of computing-related entities (systems, machines, processes, programs, libraries, functions, or the like) that facilitate or provide an agent-supervisor network. In a typical implementation, the environment typically comprises a set of computers. A representative machine is a client workstation or a network-based server running commodity (e.g. Pentium-class) hardware, an operating system (e.g., Linux, Windows 2000, OS-X, or the like), an application runtime environment (e.g., Java), and a set of applications or processes (e.g., Java applets or servlets, linkable libraries, native code, or the like, depending on platform) that provide the functionality of a given system or subsystem. A client machine typically includes a Web browser (Internet Explorer, Netscape Navigator, Apple Safari, or the like) or other rendering engine. A Web browser typically includes or supports media players and other plug-ins. The present invention implements a distributed platform that enables employees to view and bid for work schedules over a network including, without limitation, the publicly-routable Internet, a corporate intranet, a private network, or any combination thereof. The method may be implemented as a standalone product, or as a managed service offering. Moreover, the method may be implemented at a single site, or across a set of locations.

It is further noted that, unless indicated otherwise, all functions described herein may be performed in either hardware or software, or any combination thereof. In a preferred embodiment, the functions are performed by one or more processors executing given software.

In illustrative agent-supervisor network 700, a central database 702 is used to store data comprising schedules. The schedules may be accessed and modified. As will be described, the schedules are accessed and modified by one or more machines, such as a supervisor machine 704, entity A 706, entity B 708, entity C 710 and entity D 712. In this example, only four entities are shown, but in a typical implementation, there will be many more depending on the number of entities at a specific location, or across a set of locations.

As noted above, the agent-supervisor network 700 may be implemented in a number of ways, including client-server, distributed computing architecture and so on. Supervisor 704 and entity A 706, entity B 708, entity C 710, entity D 712 typically access database 702 using a Web browser or other user interface.

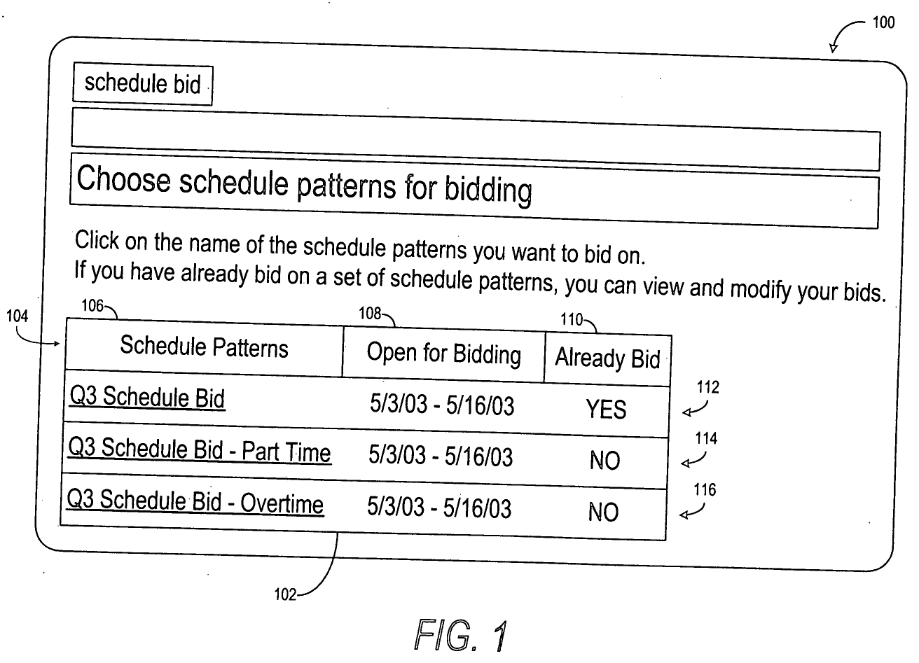

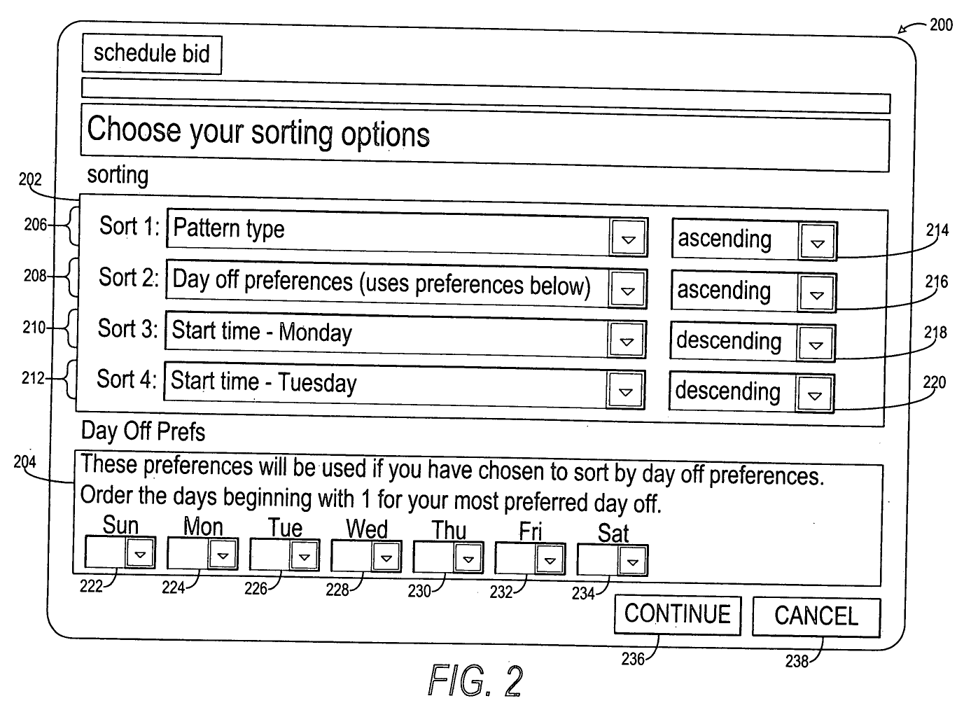

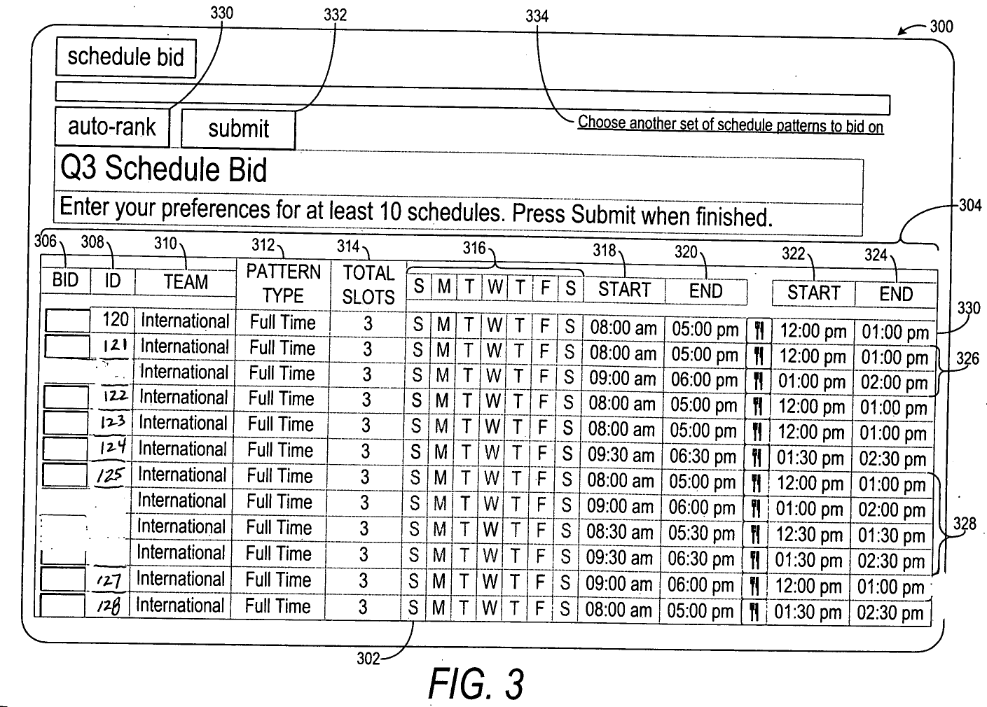

The supervisor 704 (which as used herein and depending on context refers to a person or entity, or a machine, program or process operated by such a person or entity) preferably determines when bidding on schedules is open and when it is closed. When bidding is open, preferably some or all of the entities 706, 708, 710 and 712 use a bidding home display (FIG. 1), a bid sort display (FIG. 2) and a bid screen (FIG. 3) to view schedules, define their schedule sort preferences (as will be defined below), sort schedules based on those preferences, and then attempt to bid on those schedules that match their preferences. As will be explained below, some agents, depending on their seniority, typically will end up having to bid on all schedules, since they are not likely to get their preferred schedule. According to the invention, agents bid on schedule patterns (which may be called schedules), and schedule patterns are typically grouped in a schedule pattern set. The displays in FIGS. 1-3 are merely illustrative of the inventive functionality and are not to be taken to limit the techniques to these particular user interfaces. Table 1 summarizes representative agent or employee entity displays and their function.

TABLE 1

| Agent display | Bidding home display | Bid sort display | Bid display |
|---|---|---|---|
| Function | Select a schedule | Define | View sorted |
| | pattern set for bidding | preferences for | schedules and |
| | | sorting | bid on them |

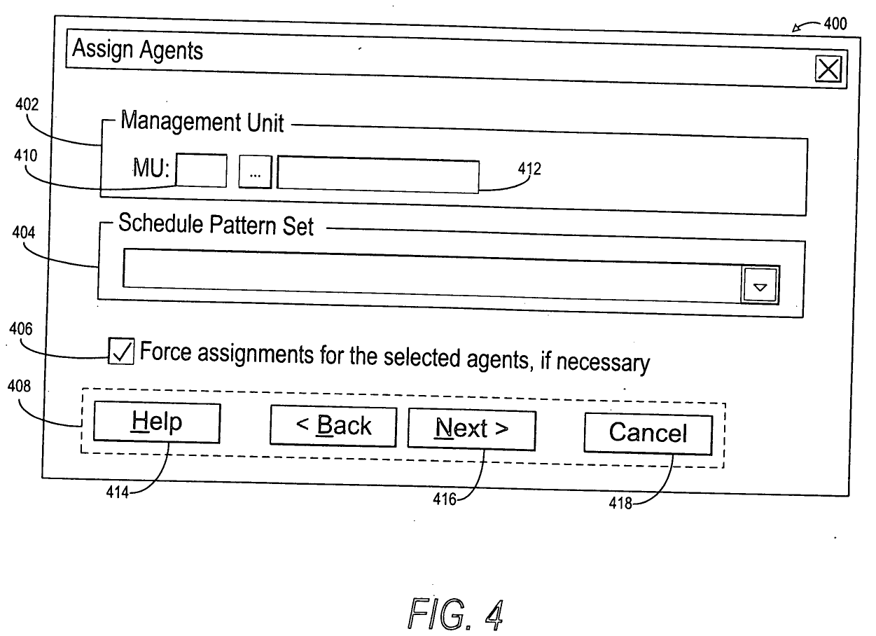

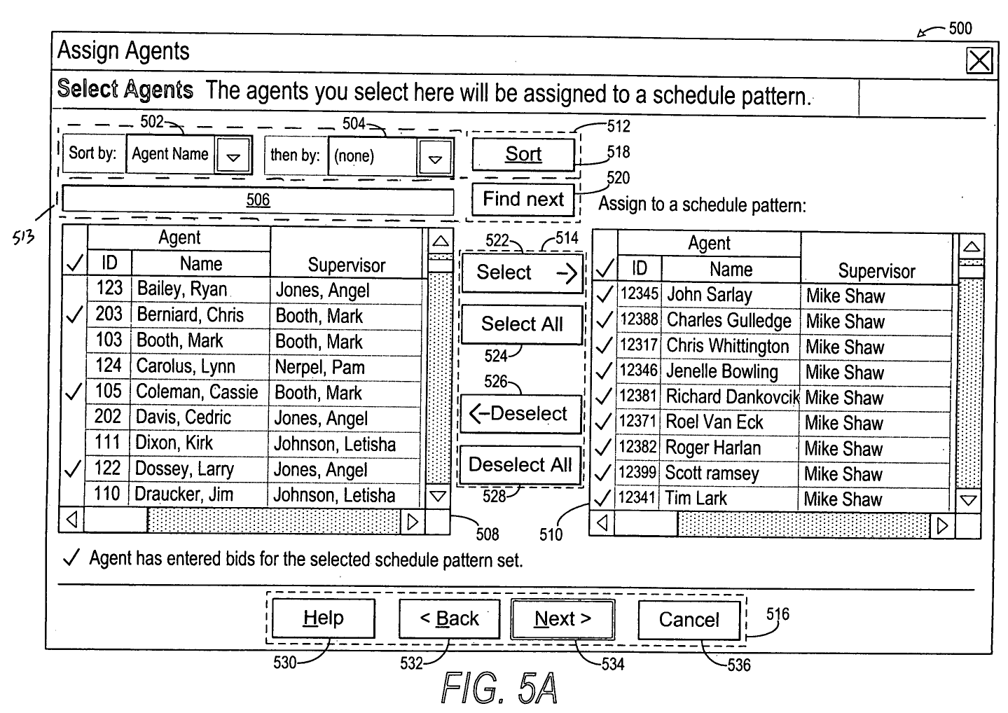

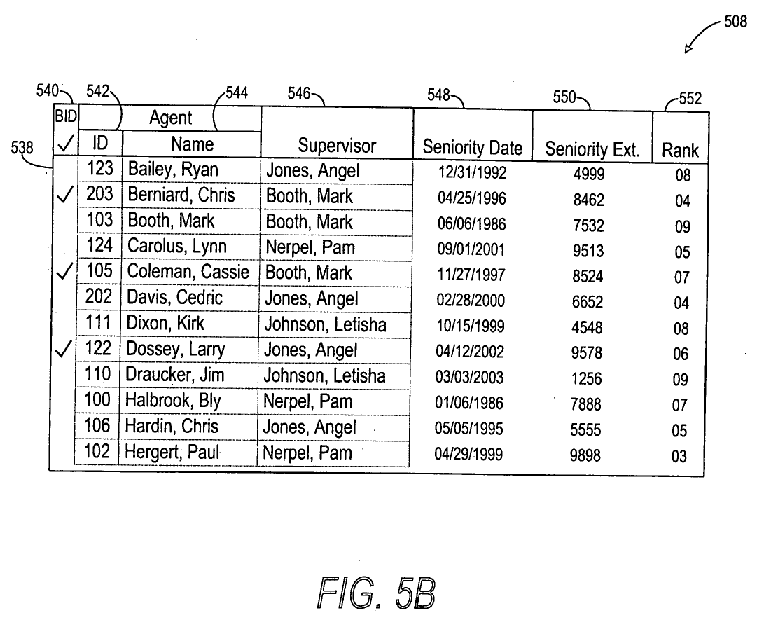

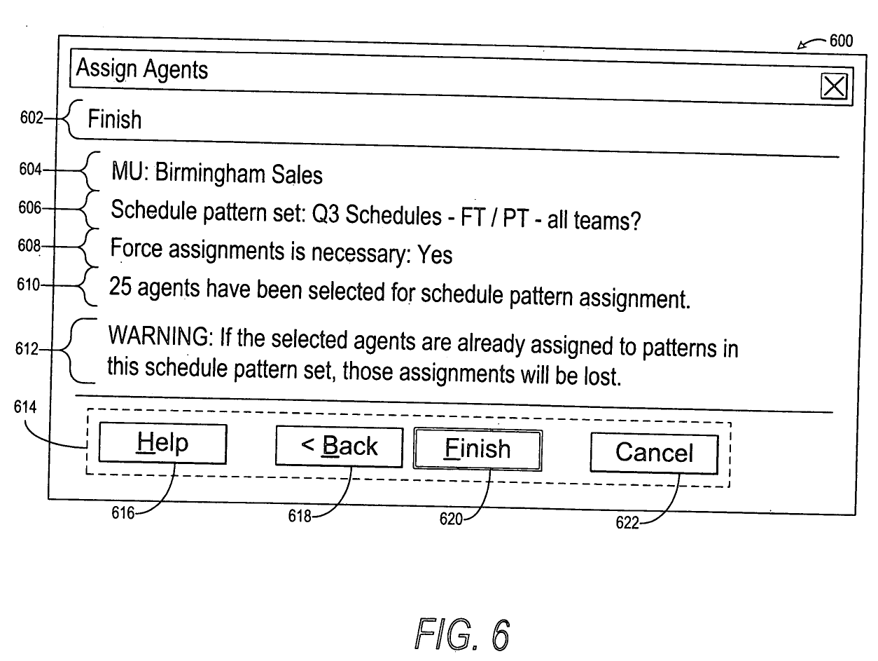

Once bidding is closed, preferably supervisor 704 uses a select schedule pattern set display (FIG. 4), a select agents display (FIG. 5), and a finish assigning agents screen (FIG. 6) to select a schedule set, select agents and assign agents to schedules. The displays in FIGS. 4-6 are also merely illustrative of the inventive functionality and are not to be taken to limit the disclosed techniques to these particular user interfaces. Table 2 summarizes the representative supervisor entity displays and their function.

TABLE 2

| | Select schedule | | Finish |
|---|---|---|---|
| Supervisor display | pattern set | Select agents | assigning agents |
| Function | Select | Select agents | Assign agents |
| | schedule | | to schedules |
| | pattern set | | |

In a particular embodiment, a particular agent operates a computer that is connectable to at least one server, with the server connectable to a computer network. In a preferred embodiment, the server provides a site or a set of pages (accessible, for example, via the public Internet, via an intranet, as an extranet application, or the like) within which given entities (e.g., agents) may view and bid on schedules. The server comprises at least one processor, a database of schedule information, and code executable on the server to facilitate the above-described functionality. As used herein, a “server” may refer to a given machine, or a set of machines or processes, whether centrally-located or distributed. The server also includes code for generating the agent displays (FIGS. 1-3) and for exporting views of those displays to client computers associated with the agents. Likewise, the server includes code for generating the supervisor displays (FIGS. 4-6) and for exporting views of those displays to client computers associated with the supervisor(s). One of ordinary skill in the art will also appreciate that other display navigation techniques may be used in lieu of or in addition to the display screens and tools shown in FIGS. 1-6.

Referring to FIG. 1 of the drawings, the reference numeral 100 generally designates a bidding home display that may be used by an entity (an agent, an employee, or the like) that desires to use the functionality.

As noted above, generally speaking, a daily schedule refers to specific time related events in an employee's daily work routine. A schedule, sometimes referred to herein as a schedule pattern, is a set of daily schedules that the employee works for a specific number of days. At a minimum, preferably a daily schedule contains information about start and end times, that is, when the employee is expected to come to work and when the employee is expected to finish work. Of course, a daily schedule may have additional time-related information, such as meal break times, coffee break times, as well as any other specific tasks or events employees are scheduled to perform or are otherwise associated with during a work day. Typically, an employee is usually assigned a specific schedule for at least a week and often for several months.

As used herein, a schedule set, also sometimes called a schedule pattern set, refers to a set of schedule patterns, usually for one contact center location, that is designed to allow a set of employees working that set of schedule patterns to adequately staff the location for the hours required to meet the location's goals. For example, if a location must provide 24/7 (24 hours a day, seven days a week) availability, the schedule pattern set assigns employees schedules in such a way that employees are available for the required hours.

On the bidding home display 100, preferably an agent selects a set of schedule patterns to bid upon from a pattern table 102. Preferably, pattern table 102 is comprised of one or more entries. A pattern table entry 104 comprises a schedule pattern set name field 106, an open dates for bidding field 108, and an already bid field 110. In this example, which is merely representative, there are three entries: full-time schedules 112, part-time schedules 114 and overtime schedules 116. On the bidding home display screen 100, preferably each agent only sees the sets of schedule patterns that a supervisor allows them to view and bid on. Thus, in an illustrative embodiment, a supervisor assigns each agent a permission level such that the agent may view and bid on only those schedule patterns the supervisor feels are appropriate for that agent. Typically, an attribute of the agent, such as whether the agent is full-time or part-time, or whether the agent is bilingual or not, is used as the basis for determining the schedule patterns that the agent may view and bid on. For example, full-time agents might only be allowed to bid on full-time schedules, so part-time schedules 114 may not be visible or they may be obscured so that such schedules cannot be selected by full-time agents. Similarly, part-time agents might only be allowed only to view and bid on part-time schedules, and agents with a certain level of seniority might be the only ones allowed to view and bid on overtime schedules. Of course, the above examples are merely illustrative and should not be taken to limit the scope of the present invention in any way.

Preferably, each set of schedules also has a corresponding bidding time period associated with it during which the agent may use bid home display 100 to bid on schedules. Preferably, new bids automatically override any previous bids placed by the agent during the bidding time period for a set of schedules. Once the bidding time period is over, bidding is said to be closed and preferably no further bids may be placed for that set of schedules. Once a schedule pattern 106 is selected, preferably the agent is taken to the next display screen illustrated in FIG. 2.

Now referring to FIG. 2, the reference numeral 200 generally designates an illustrative example of a bid sort display screen. On the bid sort display screen 200, the agent may determine or specify which factors associated with a schedule are most important to the agent. This enables the schedules available for bidding to be sorted based on each agent's preferences.

As noted above, because the supervisor may determine which factors may be viewed, the number of factors available for sorting by an agent may vary depending on what the supervisor has determined are available. In the illustrative example of FIG. 2, which is not meant to be taken as limiting, the agent is allowed to sort by four (4) different factors.

In particular, bid sort display screen 200 comprises a first portion 202 (for sorting) and a second portion (for day off preferences) 204. The first portion 202 in this illustrative example comprises four sort fields, fields 206, 208, 210 and 212, each of which has a corresponding sort order listbox, 214, 216, 218, and 220. The second portion of the display (the Day off preferences) 204 comprises seven fields corresponding to the days of the week: Sunday 222, Monday 224, Tuesday 226, Wednesday 228, Thursday 230, Friday 232, and Saturday 234.

The values available in the illustrative four sort fields 206, 208, 210 and 212 preferably depend on what the supervisor has determined may be viewed by the agent. Some examples of the values which sort fields 206, 208, 210 and 212 may have include: a pattern identifier number, team information, such as the supervisor's name, or skills required for that team, such as bilingual language skills, pattern type such as whether it is full-time, part-time or overtime, number of days off, start time for each day of the week, end time for each day of the week, total hours, paid hours, break start for each day of the week, break end for each day of the week, break length for each day of the week, total slots available, assigned slots, available slots, day off preferences, and the like. Of course, these are merely illustrative examples and are not meant to limit the present invention.

As illustrated, the sort order fields 214, 216, 218, and 220 may have the value of ascending or descending, and a listbox or other visual tool may be used to alter the setting.

If one of sort fields 206, 208, 210, or 212 has a value “day off preferences,” (as does sort field 208 in this example), then the agent is allowed to rank day off preferences, e.g., by putting a value from 1 to 7 in a “day off prefs” field, namely, one of the fields: Sunday 222, Monday 224, Tuesday 226, Wednesday 228, Thursday 230, Friday 232, and Saturday 234. Preferably, duplicate values may be assigned to two or more “day off preferences” in the day fields 222, 224, 226, 228, 230, 232 and 234 if the agent ranks them equally. Thus, for example, if the agent prefers having a Saturday or Sunday off, the agent might select “day off preferences” in one of the sort fields 206, 208, 210 or 212 and then put a value of 1 in the Sunday and Saturday fields 222 and 234, and a value from 2 to 7 in the Monday, Tuesday, Wednesday, Thursday and Friday fields 224, 226, 228, and 230.

The sort fields 206, 208, 210 and 212, and the sort orders 214, 216, 218 and 220, along with the day off preferences fields 222, 224, 226, 228, 230 and 232 work together to sort all the schedules available for bidding based on the agent's preferences. Of course, the disclosed number of fields is merely representative. Thus, for example, if the work environment does not schedule agents or employees on weekends, the Saturday and Sunday fields can be omitted or otherwise disabled.

In a representative embodiment, sort field 206, using its associated sort order 214, orders the schedules available for bidding to the agent. For schedules with the same value in sort field 206, sort field 208 and associated sort order 216 are used to sort the resulting subset of schedules. For schedules with the same value in sort field 208, sort field 210 and its associated sort order 218 are used to sort the resulting subset of schedules. For schedules with the same value in sort field 210, sort field 212 and its associated sort order 220 are used to sort the resulting subset of schedules. If one of sort orders 206, 208, 210 or 212 have the value “Day off preferences,” then the “day off preferences” portion of the display, namely, the values in fields: Sunday 222, Monday 224, Tuesday 226, Wednesday 228, Thursday 230, Friday 232, and Saturday 234 are sorted in the selected ascending or descending sort order, depending on the value of their corresponding sort order.

For example, suppose an agent prefers to have (a) Monday and Tuesday off, (b) maximum total hours, (c) a Wednesday break as early as possible and (d) a given supervisor Mike Jones. The agent can attempt to obtain a schedule with these attributes by using the display shown in FIG. 2 in the following representative manner: agent sets sort field 206 to “Day off preferences,” sort order 214 to ascending, sets day off preferences Monday 224 and Tuesday 226 to 1, sets Sunday 222, Wednesday 228, Thursday 230, Friday 232 and Saturday 234 to a value from 2 to 7, sets sort field 208 to “total hours,” sets sort order 216 to descending, sets sort field 210 to “break start—Wednesday,” sets sort field 218 to ascending, sets sort field 212 to “supervisor,” and sets sort order 220 to descending.

Typically, any of the sort fields 206, 208, 210 and 212, sort order fields 214, 216, 218, and 220, and day off preference fields 222, 224, 226, 228, 230 and 232 may be implemented using pull-down menus, free form text fields that look up the text input in a table, fill-in forms, radio buttons, or any other convenient graphical user interface widget or control.

Once the agent has defined preferences in bid sort screen 200, preferably the agent is then taken to a next display screen where the schedules available for bidding are sorted based on the preferences input by the agent.

Now referring to FIG. 3, the reference numeral 300 generally designates an illustrative bid display screen.

On bid display screen 300, the agent may view a schedule table 302 preferably comprised of one or more entries. A schedule table entry 304 comprises one or more fields, including (for example): a bid field 306, a schedule pattern ID field 308, a team field 310, a pattern type field 312, a slots field 314, a days of the week field 316, a schedule (or “shift”) start field 318, a schedule end field 320, a break start field 322 and a break end field 324. ID field 308 preferably has an identifier number for a specific schedule. For example, a schedule with shifts from Monday through Friday, starting at 9:00 am and finishing at 5:00 pm, preferably will have a different identifier in ID field 308 than, for example, a schedule with shifts from Monday through Friday, starting at 12:00 noon and finishing at 9:00 pm.

Team field 310 preferably is a supervisor defined field and may be used to indicate information about the team such as the supervisor's name, the skills required to work in that team, such as bilingual language skills, and the like.

The pattern type field 312 preferably is a supervisor-defined field and indicates a type of pattern, such as full-time, part-time, or overtime.

The slots field 314 preferably indicates a number of slots available for bidding on. For example, one schedule may have ten slots available for bidding while another schedule may only have five slots. As used herein, a slot is the number of agents who can be assigned to a particular schedule pattern.

The days of the week field 316, schedule start field 318 and shift end field 320 combine together to show a schedule start and a schedule end time for each day of the week for the particular schedule. As illustrated in FIG. 3, each row of the table (which may represent a record in a database) is a daily schedule pattern. Reference numerals 326, 328 and 330 each represent weekly schedule patterns. The weekly schedule pattern 326 has two (2) daily schedules associated therewith. Weekly schedule pattern 328 has four (4) daily schedules associated therewith, and weekly schedule pattern 330 has one (1) daily schedule pattern associated therewith. These are merely illustrative.

More specifically, schedule record 330 corresponds to a schedule on Monday, Tuesday, Wednesday, Thursday and Friday that starts at 8:00 am and ends at 5:00 pm.

The group of schedule records identified by reference number 326 correspond to the following schedules: Monday, Wednesday and Friday that start at 8:00 am and end at 5:00 pm, and schedules on Tuesday and Thursday that start at 9:00 am and end at 6:00 pm. The group of schedule records 328 correspond to the following schedules: Monday and Friday schedules that start at 8:00 am and end at 5:00 pm, a Tuesday schedule that starts at 9:00 am and ends at 6:00 pm, a Wednesday schedule that starts at 8:30 am and ends at 5:30 pm, and a Thursday schedule that starts at 9:30 am and ends at 6:30 pm.

It should be noted that in this example the schedule start 318 and schedule end 320 are shown. However, in a variation, the start time and the length of the schedule may be shown. In still another variation, only the start time may be shown, if all schedules are already known to be of a fixed length, such as nine hours.

Break start field 322 and break end field 324 indicate when a break, such as a lunch or dinner break, is scheduled. In another implementation, only the break start may be shown, e.g., if all breaks are already known to be of a fixed length, such as one hour.

The supervisor may set the fields that are shown for each set of schedules available for bidding. Thus, the supervisor may determine which schedules are shown, as well as the amount of information displayed for each schedule, such as when the shift starts, when the break starts, how many slots are available, and the like.

As previously mentioned, preferably the schedules shown on bid display screen 300 are sorted based on the agent's preferences entered on bid sort screen 200. Then, on bid display screen 300, the agent may rank schedules automatically or manually. To automatically rank the schedules, the agent may select an auto-rank control 330, which (upon selection) ranks the schedules in the order they appear on bid display screen 300, i.e. sorted based on the preferences originally input by the agent. Selecting the auto-rank function 330 preferably results in bid field 306 of schedule record 304 being filled in for each schedule entry in the table.

Alternately, the agent may rank schedules manually by entering a value in bid field 306, e.g., a unique number from 1 to 9999. Thus, if an agent is ranking 10 schedules, he or she may enter the numbers 1 through 10, in each bid field 306 of the 10 records the agent wishes to rank, with (for example) 1 indicating the highest priority bid and 10 indicating the lowest priority bid.

Once the schedules are ranked, either automatically (by using the auto-rank button 330) or manually (by entering a unique number in bid field 306 for each schedule record the agent wishes to rank), the agent enters the selection, e.g., by using a submit button 332 (or other convenient user selection) to submit the agent's bids.

As previously mentioned, the agent may go back to the bid home display screen 100 to select a set of schedules, enter new sorting preferences in bid sort display screen 200, and again bid on schedules using bid display 300, until bidding is closed. Of course, other agents are using these displays for the same purposes themselves. The system collects the data entered by the agents. Once bidding is closed, the supervisor can then proceed to assign schedules to agents. This process is now described.

Although not meant to be limiting, typically a schedule is assigned to an agent for an extended period, such as a calendar quarter (three months), two calendar quarters (six months), and the like. Near the end of each previously assigned scheduling period, the supervisor typically posts online a new set of schedules for bidding online, agents enter bids for the new schedules online (as has been described above), and new schedules are assigned to agents for the next extended time period.

Now referring to FIG. 4, the reference numeral 400 generally designates a representative select schedule pattern set display.

In particular, once agent bidding is closed, the supervisor preferably begins the schedule assignment process at the select schedule pattern set display 400, which preferably comprises a management unit selector portion 402, a schedule pattern set selector portion 404, a force assignments checkbox 406, and a navigation control portion (e.g., a control box) 408. A “management unit” preferably is a set of one or more employees at a given level that are managed or manageable by a given entity (e.g., a supervisor) collectively. The present invention is not limited to schedule bidding in the context of management units, of course. Management unit selector portion 402 preferably comprises a management unit number 410 and a management unit name field 412. This portion of the display may be omitted if management units are not used. Navigation box 408 preferably comprises a help button 414, a next button 416, and a cancel button 418.

In an illustrative embodiment, the supervisor or other management entity typically enters a number of the management unit in management unit number field 410, and the name of the management unit is found in a table and displayed in management unit name 412. The associated schedule pattern sets available for that management unit are then displayed in schedule pattern set field 404. As noted above, the management unit is usually a group of agents at the site (location) for which schedules are being assigned by the supervisor. Typically, the schedule pattern set is a group of similar schedule patterns, such as full-time schedule patterns for an extended time period (such as a calendar quarter).

Pull-down menus, free-form text fields that look up values in a table, or other well known methods, may be used for selecting the management unit number 410, management unit name 412 and schedule pattern set 404.

The supervisor may force assignments for selected agents, if desired, by checking the force assignments checkbox 406. Typically, this forcing function is used towards the end of the assignment process and will be discussed in more detail below.

The supervisor may select help button 414 to display a page with information on how to complete the select schedule pattern set display 400. The supervisor may select cancel button 418 to cancel any selections made and return to a supervisor home page; alternatively the cancel button may just close the window. Once the supervisor has selected a schedule pattern set 404 in a management unit number 410 and (if necessary) has checked force assignments checkbox 406, the supervisor may select a next button 416 to proceed to the next display screen.

Now referring to FIG. 5A, the reference numeral 500 generally designates an illustrative select agents display page.

Select agents page 500 may include a Sort by field 502, a Then by field 504, a Find value field 506, an Agent select table 508, an Assign agent table 510, a Sort button 518, a Find next button 520, a Select button 522, a Select All button 524, a Deselect button 526, and Deselect All button 528.

The Sort by field 502, the Then by field 504, and the Sort button 518 comprise a set of sorting functions 512. The Find value field 506 and the Find next button 520 comprise a set of finding functions 513. The Select button 522, the Select All button 524, the Deselect button 526, and the Deselect All button 528 comprise a set of selecting functions 514. Navigation functions 516 preferably comprise Help button 530, Back button 532, Next button 534 and Cancel button 536.

Agent select table 508 and Agent assign table 510 preferably comprise one or more data records, with each data record 538 (see FIG. 5B) preferably containing information on agents who may be available to work a schedule. As seen in FIG. 5B, which is an Agent select table 508 shown in a full display format, a given data record comprises a bid indicator field 540, an agent ID field 542, an agent Name field 544, a Supervisor field 546, a Seniority Date field 548, a Seniority Extension field 550 and a Rank field 552.

As noted above, in the select schedule pattern set display 400, the supervisor selects the management unit 402 and the schedule pattern set 404 before selecting next button 416 to get to select agents page 500. Thus, the schedule pattern set has already been selected and the supervisor may now choose agents that are to be assigned to schedules using the select agents page 500.

Agent select table 508 preferably shows the records for agents who may be selected to be assigned to schedules, while Agents assigned table 510 shows the records for all agents who will be assigned to schedules in the schedule pattern set. Typically, when the supervisor starts, Agents assigned table 510 will be empty. Alternatively, table 510 may be pre-populated with given information.

Typically, the supervisor sorts by specific fields in table 510, for example, by (i) setting a value in Sort by field 502, (ii) setting a value in Then by field 504, and then (iii) using the Sort button 518. Both the Sort by field 502 and the Then by field 504 may have one or more values such as: bid flag, agent ID, agent name, and a user-definable column, such as supervisor, seniority date, seniority extension, rank and none. Sort by field 502 and Then by field 504 may be implemented using any convenient interface method such as pull-down menus, free form text fields with a table lookup, radio buttons, or the like.

The supervisor may enter text, such as an agent name, in the Find value field 506 and then use the Find next button 520 to find (in agent select table 508) a next occurrence of the text entered in the Find value 506.

Again referring to FIG. 5B, preferably each record 538 has the agent's name 544 and agent ID 542. Bid field 540 indicates whether the agent bid on the selected schedule pattern set or not. Supervisor field 546 has the name of the agent's supervisor. Seniority date field 548 preferably contains the date used to determine the agent's seniority, such as the agent's start date with the company. A seniority extension field 550 may also be available and is useful as a tiebreaker. Thus, if seniority ranking is used and two or more agents have the same amount of seniority, i.e. their seniority date is the same, then the seniority extension may be used as a tie-breaker to determine the order in which the two agents will be processed.

Rank field 552 indicates a number related to the employee, for example, for purposes of aiding the supervisor in ranking employees. For example, rank field 552 might be a numerical value representing the agent's performance, the agent's seniority, a combination of performance and seniority, or any other supervisor-selected metric.

Typically, when assigning agents to schedules, agents are ordered based on their seniority, using seniority date field 548, or based on their performance ranking, using rank field 552. Thus, if seniority ranking is used, then the agent with the most seniority will be processed first, and the agent with the lowest seniority will be processed last. Similarly, if performance ranking is used, the agent with the highest performance ranking will be processed first and the agent with the lowest performance ranking will be processed last. These are merely illustrative approaches, however.

The supervisor may select and transfer records between agent select table 508 and agent assign table 510 using selection buttons 514. All records in Agent select table 508 may be selected using the Select All button 524, or the supervisor may individually select one or more records in Agent select table 508. The selected record(s) may then be transferred from Agent select table 508 to Agent assign table 510 using Select button 522. All records in Agent assign table 510 may be deselected using Deselect All button 528, or the supervisor may individually select one or more records in Agent assign table 510. The records selected in Assign agent table 510 may then be transferred back to Agent select table 508 using Deselect button 526. The agent records that will remain in Agent select table 508 typically include records for the agents who did not bid on the schedule. For example, agents whose schedule assignment is not changing, or agents who are to be assigned to a schedule in a different schedule pattern set, may be left in the Agent select table 508. Of course, this example is not meant to be taken to limit the present invention in any way.

As noted above, the supervisor may select Help button 530 to display a page with information on how to use the Select agents page 500. The supervisor may select Back button 532 to return to the previous display screen and select a different schedule pattern set. The supervisor may select Cancel button 536 to cancel any selections made and return to the supervisor home page; alternatively the cancel button may just close the window.

Once Assign agents table 510 contains the records for all the agents that the supervisor wishes to assign to schedules in the selected schedule pattern set, the supervisor may use the Next button 534 to proceed to the next display screen.

Now referring to FIG. 6, the reference numeral 600 generally designates an illustrative finish assigning agents display screen.

Finish assigning agents display 600 preferably comprises a status field 602, a management unit MU field 604, a schedule pattern set field 606, a force assignment field 608, a confirmation field 610, a warning field 612 and one or more navigation buttons 614. Navigation buttons 614 preferably comprise a Help button 616, a Back button 618, a Finish button 620 and a Cancel button 622.

In finish assigning agents page 600, the supervisor preferably receives confirmation regarding the schedule pattern set assigned to one or more agents using the select agents display screen 500 of FIG. 5A. Status 602 indicates that the supervisor will finish assigning the selected agents to the selected schedule pattern set 606, preferably by using Finish button 620.

The MU field 604 preferably indicates the management unit number and name. As noted above, typically this refers to a unique management unit number and name identifying a group of agents at a location where agents are employed. In this example, the management unit name is Birmingham Sales. The Schedule pattern set field 606 preferably indicates which schedule pattern set has been selected for assigning agents. In this example, the full-time (FT) and part-time (PT) schedules for the third quarter, for all teams, have been selected. Of course, this is merely representative.

The Force assignment field 608 indicates whether force assignments checkbox 406 was selected in select schedule pattern display screen 400. The Confirmation field 610 indicates the number of agents that the supervisor selected for assigning to schedules in the select agents display 500. The Warning field 612 indicates that if any of the selected agents were previously assigned patterns in this schedule pattern set, those assignments will be lost, e.g., once the supervisor uses the Finish button 620.

The supervisor may select Help button 616 to display a page with information on how to use the finish assigning agents display 600. The supervisor may select Back button 618 to return to the previous display screen. The supervisor may select Cancel button 622 to cancel any selections made and return to the supervisor home page; alternatively the cancel button may just close the window.

Once the supervisor has completed reviewing the information on finish assigning agents display page 600, the supervisor may use Finish button 620 to complete the assignment of the agents in 610 to the schedule pattern set in 606 with respect to the identified management unit MU 604.

The selected agents are then each assigned a schedule. As noted above, preferably agents are processed in either seniority order or rank order, depending on the method specified for the management unit. Preferably, an agent is assigned to his or her highest-ranked schedule, if the schedule is available. If all of the schedule's slots have been assigned to other agents, then the agent preferably is assigned to his or her next highest-ranked schedule, if that schedule is available, and so on. If none of the schedules that an agent bid on are available, or if the agent did not enter bids for any schedules, then the agent is not assigned a schedule, perhaps unless the force assignments checkbox 406 has been selected. If the force assignments box 406 has been selected, once all of the agents have been processed, schedules may be assigned to agents that remain unassigned. Preferably, an agent will only be assigned to a schedule that he or she was allowed to bid on, e.g., based on his or her assigned permissions and attributes.

The schedule bidding feature of the present invention provides numerous advantages. It allows entities being scheduled (agents, employees, or others) the ability to enter bids for schedule patterns, e.g., using a Web browser-based interface. A process can then be run to assign those entities to schedule patterns, based on those bids and each agent's seniority, rank, a combination thereof, or some other suitable metric. In a variation, supervisors may use the tool to see, modify and delete schedule pattern bids. The invention further allows a supervisor to control exactly what parameters employees are allowed to see. For example, some supervisors may want their employees to see lunch times, while others may not, etc. Supervisors preferably specify the fields that are shown, possible exceptions that are shown, and the types of schedules that employees may bid on (e.g., full time, part time, overtime, schedules for certain skills, schedules for certain teams, etc.) In addition, preferably supervisors can assign permissions to employees that determine which type of schedules the employee can bid on. This feature allows multiple sets of schedules to be open for bidding at once, each with its own set of parameters. For example, a normal bid may be open at the same time as an overtime bid, or a holiday bid. This invention also preferably provides an auto-rank feature that allows employees to sort the schedules in a desired order, enter rankings for specific schedules if they wish, and to automatically rank the remaining schedules in a current order.

In an illustrative embodiment, once a given schedule pattern set is closed for bidding, the supervisor preferably initiates a process that assigns agents to schedule patterns based on their bids and on a ranking method selected by the supervisor. The supervisor can select the agents that are to be included in this processing, and the supervisor may also indicate whether those agents' previous assignments are to be honored. The system preferably only assigns an agent to one schedule pattern during the assignment process, which preferably takes place as a batch operation. The supervisor can also decide to force an assignment for each of the selected agents. Assignments may be forced if an agent did not enter any bids or if all of the schedule patterns for which the agent did enter bids have been assigned to other agents.

The invention may be extended to provide additional functionality. Thus, it may be desirable to allow employees to bid on a schedule that becomes available after another employee has changed schedules or left the company. For example, if an employee were to leave the company, then his or her old schedule may be offered to employees in seniority order, or by some ranking, or according to who had bid on that schedule during a last schedule bid, etc. Once an employee is assigned to the schedule, his or her old schedule would then become available for others to bid on, and so on. In another alternative, it may be desirable to have the system implement the above-described bidding technique whereby the agents bid for individual days of a given week.

The present invention is also advantageous as it enables the work center management to provide evidence that a particular agent received the best possible schedule available (given the agent's particular seniority or other ranking). Indeed, given the automated approach implemented in the present invention, the system can readily generate reports showing which agents got which schedules and that a particular agent was assigned a given schedule only after those agents with higher seniority and/or ranking got the schedules they had requested. Such a reporting functionality also facilitates generating evidence to comply with union or other legal requirements.

The automated functionality of the present invention also enables schedule bidding to take place on a much more frequent basis as compared to prior art manual techniques. This enables a new set of schedules to be generated and made to closely match contact center demand curves on a much more frequent and realistic basis.

In an illustrative embodiment, the agents are assigned to schedules using a computer-based agent scheduling program, such as TotalView, available from IEX, a Tekelec company. Any other computer-based program for scheduling agents to a set of schedules according to given metrics (e.g., seniority, ranking, or the like) can be used.

It will be understood from the foregoing description that various modifications and changes may be made in the preferred embodiment of the present invention without departing from its true spirit. This description is intended for purposes of illustration only and should not be construed in a limiting sense. The scope of this invention should be limited only by the language of the following claims.

1. A method operative in a work environment wherein entities to be scheduled each access a computer network using a client computer, comprising:
during a given time period, enabling each of a set of entities, irrespective of their seniority or ranking in the work environment, to identify a given schedule pattern set and to identify a set of one or more bids with respect to one or more schedules that are associated with that given schedule pattern set;
at the close of the given time period, selecting a given set of the entities for scheduling with respect to the given schedule pattern set; and
assigning the given set of the entities to one or more of the candidate schedules that are associated with the given schedule pattern set;
wherein one or more of the steps are performed at least in part using one or more processing devices.

2. The method as described in claim 1 further including the step of:
enabling the given entity to identify a set of sorting preferences associated with the given schedule pattern set.

3. The method as described in claim 2 further including the step of enabling an entity to identify a new given schedule pattern set and an associated set of sorting preferences during the given time period.

4. The method as described in claim 1 further including the step of enabling an entity to select a different schedule pattern set, and to identify a set of one or more bids associated with the different schedule pattern set during the given time period.

5. The method as described in claim 1 wherein the entity ranks the set of one or more bids associated with the given schedule pattern set.

6. The method as described in claim 1 further including the step of automatically ranking the set of one or more bids associated with the given schedule pattern set.

7. The method as described in claim 1 further including the step of assigning a schedule to at least one entity that did not provide a bid for any candidate schedules that are associated with the given schedule pattern set.

8. The method as described in claim 1 further including the step of deselecting a given set of the entities for scheduling with respect to the given schedule pattern set.

9. Apparatus, for use in a work environment wherein entities to be scheduled each access a computer network using a client computer, comprising:
a processor;
code executable by the processor during a given time period to enable each of a set of entities, irrespective of their seniority or ranking in the work environment, to identify a given schedule pattern set and to identify a set of one or more bids with respect to one or more schedules that are associated with that given schedule pattern set;
code executable by the processor at the close of the given time period and responsive to selection of a given set of the entities for scheduling with respect to the given schedule pattern set for assigning the given set of the entities to one or more of the candidate schedules that are associated with the given schedule pattern set.
